(19) United States
(12) Patent Application Publication
(10) Pub. No.: US 2025/0237389 A1
(43) Pub. Date: Jul. 24, 2025

(54) COOKING APPARATUS

(71) Applicant: SAMSUNG ELECTRONICS CO., LTD., Suwon-si (KR)

(72) Inventors: Gongsoo KIM, Suwon-si (KR); Jihun HWANG, Suwon-si (KR)

(73) Assignee: SAMSUNG ELECTRONICS CO., LTD., Suwon-si (KR)

(21) Appl. No.: 19/174,524

(22) Filed: Apr. 9, 2025

Related U.S. Application Data
(63) Continuation of application No. PCT/KR2023/016384, filed on Oct. 20, 2023.

(30) Foreign Application Priority Data
Nov. 21, 2022 (KR) 10-2022-0156768
Jan. 6, 2023 (KR) 10-2023-0002453

(51) Int. Cl. F24C 7/08

(52) U.S. Cl. CPC F24C 7/082

(57) ABSTRACT

A cooking apparatus including: a heat source; a control panel; a regulator body capable of operating the heating source and positioned adjacent to the control panel; a shaft coupled to the regulator body so as to be movable to a first shaft position where rotation with respect to the regulator body is restricted or a second shaft position where rotation relative to the regulator body is possible to operate the heating source; and a knob coupled to the shaft to be movable with the shaft; and a locking device provided on the knob, wherein the locking device includes a locker that is movable to a locking position where the locker is inserted into the control panel to prevent rotation of the knob while the shaft is in the second shaft position or an unlocking position where the locker is separated from the control panel to allow rotation of the knob.

### CROSS-REFERENCE TO RELATED APPLICATIONS

This application is a continuation of International Application No. PCT/KR2023/016384, filed Oct. 20, 2023, which is incorporated herein by reference in its entirety, and claims foreign priority to Korean Application No. 10-2022-0156768, filed Nov. 21, 2022, and Korean Application No. 10-2023-0002453, filed Jan. 6, 2023, which are incorporated herein by reference in their entireties.

### TECHNICAL FIELD

The present disclosure relates to a cooking apparatus, and more particularly, to a cooking apparatus including a knob assembly.

### BACKGROUND ART

In general, a cooking apparatus is a home appliance that cooks food by including a cooking chamber, a heating device configured to apply heat to the cooking chamber, and a circulation device configured to circulate heat generated by the heating device inside the cooking chamber. Cooking apparatuses, as apparatuses for cooking food by sealing and heating the food, may be classified into electric, gas, and electronic cooking apparatuses according to a heat source of the heating device. For example, electric ovens use heat of a heater driven by electricity as a heat source, gas ovens use heat generated by using gas as a heat source, and microwave ovens use frictional heat of water generated by high frequency as a heat source.

A control panel may be provided on either the front surface or the top surface of a main body of the cooking apparatus. The control panel may include a plurality of buttons, a keypad, and/or a knob assembly configured to set a cooking mode desired by a user or various conditions required for cooking.

A controller to control the heating device may operate in a push and turn manner. A knob assembly configured to operate a controller may control the operation of a cooking apparatus by a two-step mechanism including applying a pressure to a control shaft of the controller upon being pressed and turning.

Meanwhile, unintentional operation of the knob assembly by the user may cause fires and/or burns.

### DISCLOSURE

### Technical Problem

Provided are a knob assembly configured to prevent malfunctions and a cooking apparatus including the same.

Provided are a knob assembly configured to prevent malfunctions in a turning operation and a cooking apparatus including the same.

Provided is a cooking apparatus in which a regulator device does not operate unless an additional operation such as pressing a button is performed.

Provided is a cooking apparatus in which a locker restricting movement of a knob assembly is moved by pressing a button.

However, the technical problems to be solved by the present disclosure are not limited to the aforementioned problems, and any other technical problems not mentioned herein will be clearly understood from the following description by those skilled in the art to which the present disclosure pertains.

### Technical Solution

In accordance with an aspect of the present disclosure, a cooking apparatus includes a heat source, a control panel, a regulator body configured to operate the heat source and located adjacent to the control panel, a shaft engaged with the regulator body and configured to move between a first shaft position, where rotation with respect to the regulator body is restricted, and a second shaft position, where rotation with respect to the regulator body is possible to operate the heat source, a knob engaged with the shaft to move together with the shaft, and a locking device provided at the knob and including a locker configured to move between a locking position, where the locker is inserted into the control panel to prevent the knob from being turned, and a unlocking position, where the locker is disengaged from the control panel to allow the knob to be turned, while the shaft is located at the second shaft position.

The cooking apparatus may further include a button configured to move between a first button position, where a movement of the locker from the locking position to the unlocking position is restricted, and a second button position, where a movement of the locker from the locking position to the unlocking position is allowed, wherein the button may include a pressure-applying protrusion configured to apply a pressure to the locker to move from the unlocking position to the locking position while the button moves from the first button position to the second button position.

The pressure-applying protrusion may have a pressure-applying surface that is contactable with the locker, wherein the pressure-applying surface is inclined more toward the control panel in a direction from the first button position to the second button position of the button.

The locker may include a locker support having a protrusion-accommodating space in which the pressure-applying protrusion is accommodated, wherein the locker support moves by a pressure applied from the pressure-applying surface while the button moves from the first button position to the second button position.

The regulator body may further include a case having a stopper groove, and the shaft may include a shaft body at least partially inserted into the case and a stopper protruding from the shaft body to be accommodated in the stopper groove while the shaft is located at the first shaft position and to be separated from the stopper groove while the shaft is located at the second shaft position.

The control panel may have a locking hole provided at a position corresponding to the locker to accommodate the locker while the locker is located at the locking position.

A moving distance of the locker from the locking position to the unlocking position may be greater than a moving distance of the shaft from the first shaft position to the second shaft position.

The cooking apparatus may further include a locker elastic member between the knob and the locker to apply a pressure to the locker from the unlocking position to the locking position.

The button may include a button hook extending through the protrusion-accommodating space to guide the button.

The cooking apparatus may further include a button elastic member between the locker and the button to apply a pressure to the button from the second button position to the first button position in a case where the locker is located at the unlocking position.

The button may have a seating gap to accommodate a portion of the button elastic member and located between the button hook and the pressure-applying protrusion to mount the button elastic member on the button.

The button may include a button-grasping area from which the pressure-applying protrusion extends, and a support flange extending outward from the button-grasping area to prevent the button from being separated outward from the knob.

The support flange may be a lower support flange located at a lower position to prevent the button from extending downward beyond the button hook so as to linearly insert the button into the protrusion-accommodating space.

An end of the locker facing the regulator body may have a tapered shape so as to be insertable into the locking hole.

The pressure-applying surface may substantially have an angle of 45 degrees or less.

In accordance with an aspect of the present disclosure, a cooking apparatus includes a housing including a control panel, a regulator device including a regulator body and a shaft penetrating the control panel and rotatable between a first shaft position, where rotation with respect to the regulator body is restricted, and a second shaft position, where rotation with respect to the regulator body is allowed, and a knob assembly coupled to the shaft to move together with the shaft. The knob assembly may include a locking device including a locker which moves between a locking position, in which the locker is inserted into the control panel to prevent the knob assembly from being turned and a unlocking position, in which the locker is separated from the control panel to allow the knob assembly to be turned, while the shaft is located at the second shaft position, and a button which move between a first button position, where movement of the locker from the locking position to the unlocking position is restricted, and a second button position, where movement of the locker from the locking position to the unlocking position is allowed.

The pressure-applying protrusion may have a pressure-applying surface in contact with the locker, and the pressure-applying surface is more inclined toward the control panel in a direction from the first button position to the second button position of the button.

The locker may include a locker support having a protrusion-accommodating space in which the pressure-applying protrusion is accommodated, wherein the locker support moves in a state of being pressed by the pressure-applying surface while the button moves from the first button position to the second button position.

The regulator body may further include a case having a stopper groove, and the shaft may include a shaft body at least partially inserted into the case, and a stopper protruding from the shaft body to be accommodated in the stopper groove while the shaft is located at the first shaft position and to be separated from the stopper groove while the shaft is located at the second shaft position.

In accordance with an aspect of the present disclosure, a cooking apparatus includes a control panel, a regulator body located to face one side of the control panel, a shaft at least partially inserted into the regulator body, and a knob assembly located on the other side of the control panel and coupled to the shaft, wherein the knob assembly includes a locking device including a locker movable between a locking position, where the locker is inserted into the control panel to prevent the knob assembly from being turned, and a unlocking position, where the locker is separated from the control panel to allow the knob assembly to be turned.

### Advantageous Effects

According to the present disclosure, malfunctioning of the cooking apparatus may be prevented by including a regulator device operating in a push and turn manner, and a locker configured to prevent a knob assembly coupled to the regulator device from being turned.

According to the present disclosure, the cooking apparatus includes a locker insertable into a control panel, and malfunctioning of the cooking apparatus in a turning operation of the knob assembly may be prevented by inserting the locker into the control panel.

According to the present disclosure, by pressing the button of the cooking apparatus, the locker moves to the inside of the knob assembly allowing the knob assembly to be turned, and accordingly, the regulator device may not operate unless an additional operation, such as pressing the button, is performed.

According to the present disclosure, by pressing the button of the cooking apparatus, the locker configured to restrict the movement of the knob assembly may move in a manner of moving along the inclined pressure-applying surface of the button.

According to the present disclosure, the locker support included in the cooking apparatus and brought into contact with the locker may prevent the locker from causing scratches on the control panel.

### DESCRIPTION OF DRAWINGS

FIG. 1 is a perspective view of a cooking apparatus according to an embodiment of the present disclosure.

FIG. 2 is a front view of the cooking apparatus illustrated in FIG. 1.

FIG. 3 is a cross-sectional view of the cooking apparatus illustrated in FIG. 1 taken along line III-III′

FIG. 4 is an enlarged view illustrating a portion of the cooking apparatus shown in FIG. 1 where a knob assembly N is located.

FIG. 5 is a perspective view illustrating the regulator device shown in FIG. 4.

FIG. 6 is an exploded perspective view of the regulator device shown in FIG. 5.

FIG. 7 is a cross-sectional view of the regulator device shown in FIG. 5 taken along line VII-VII′.

FIG. 8 is a rear perspective view illustrating that the shaft is inserted into the outer cover of the regulator device shown in FIG. 6.

FIG. 9 is a perspective view of the knob assembly illustrated in FIG. 4.

FIG. 10 is an exploded view of the knob assembly illustrated in FIG. 9.

FIG. 11 is an exploded view of the knob assembly illustrated in FIG. 10 viewed at another angle.

FIG. 12 is an exploded view of a locking device illustrated in FIG. 10.

FIG. 13 is an exploded cross-sectional view of the knob assembly illustrated in FIG. 9 taken along line VIII-VIII′ in which the button is located at the first button position.

FIG. 14 is an exploded cross-sectional view of the knob assembly illustrated in FIG. 13 in which the button is located at the second button position.

FIG. 15 is a cross-sectional view of the knob assembly shown in FIG. 9 taken along line XV-XV′ shown in FIG. 2 in which the knob assembly is mounted on the shaft of the regulator device in the case where the button is located at the first button position.

FIG. 16 is a cross-sectional view of the knob assembly of FIG. 15 in the case where the button is located at the second button position.

FIG. 17 is a cross-sectional view of the knob assembly of FIG. 16 in the case where the knob moves from a first knob position to a second knob position.

FIG. 18 is a cross-sectional view illustrating a knob assembly of a cooking apparatus according to an embodiment of the present disclosure and components related thereto.

FIG. 19 is a cross-sectional view of a knob assembly of a cooking apparatus according to an embodiment of the present disclosure.

FIG. 20 is a cross-sectional view of a knob assembly of a cooking apparatus according to an embodiment of the present disclosure.

FIG. 21 is a cross-sectional view of a knob assembly of a cooking apparatus according to an embodiment of the present disclosure and components related thereto.

### MODES OF THE INVENTION

Various embodiments of the present disclosure and terms used herein are not intended to limit technical features disclosed herein to particular modes of practice, and it is to be appreciated that all changes, equivalents, and substitutes of the embodiments are encompassed in the present disclosure.

Regarding the description of the drawings, like reference numerals may be used for like or related elements throughout the drawings.

The singular form of a noun corresponding to an item may include one or more items unless the context states otherwise.

Throughout the specification, “A or B”, “at least one of A and B”, “at least one of A or B”, “A, B or C”, “at least one of A, B and C”, and “at least one or A, B, or C” may each include any one or all the possible combinations of A, B and C.

The term “and/or” is interpreted to include a combination or any of associated elements.

Terms such as “first” or “second” are used to distinguish one component from other components and, therefore, the components are not limited by the terms in any other aspect (e.g., importance or order).

When an element (e.g., first element) is mentioned as being “coupled” or “connected” to another element (e.g., second element) with or without an adverb “functionally” or “communicatively”, it means that the element may be connected to the other element directly (e.g., by wires), wirelessly, or via a third element.

The terms such as “including” or “having” are intended to indicate the existence of features, numbers, processes, operations, components, parts, or combinations thereof disclosed in the specification, and are not intended to preclude the possibility that one or more other features, numbers, processes, operations, components, parts, or combinations thereof may exist or may be added.

When an element is mentioned as being “connected to”, “coupled to”, “supported by”, or “contacting” another element, it includes not only a case that the elements are directly connected to, coupled to, supported by or contact each other but also a case that the elements are connected to, coupled to, supported by or contact each other through a third element.

When an element is mentioned as being located “on” another element, it implies not only that the element is in direct contact with the other element but also that a third element exists between the two elements.

Meanwhile, the terms used herein such as “upward-downward direction”, “lower”, and “forward-backward direction” are defined based on the drawings, and the shapes and positions of the components are not limited by these terms.

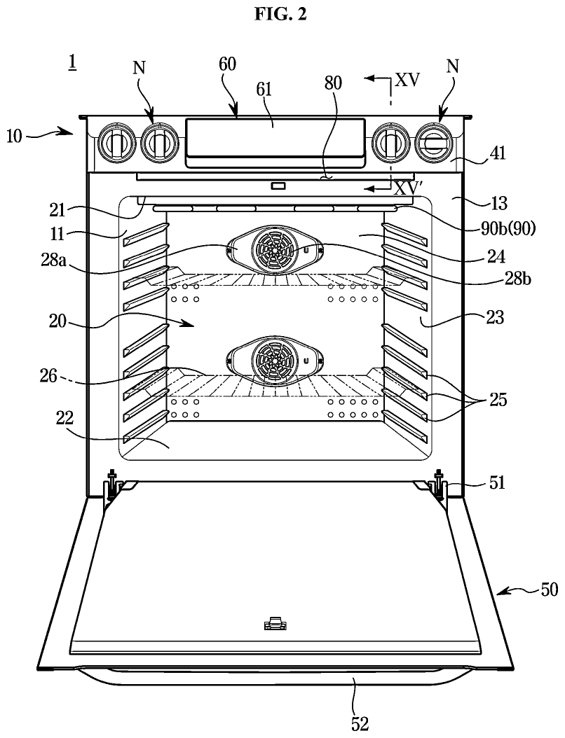

Specifically, as shown in FIG. 2, a direction of an open side of a cooking chamber of a cooking apparatus 1 is defined as a forward direction, and backward, leftward, rightward, upward, and downward directions are defined based thereon.

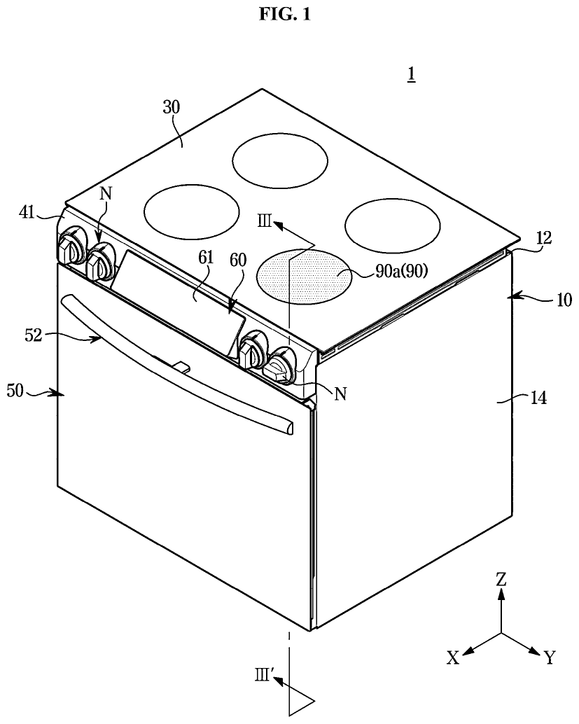

Particularly, regarding X, Y, and Z directions shown in FIG. 1, +X direction is defined as forward direction, +Y direction is defined as leftward direction, +Z direction is defined as upward direction, and other directions are defined based thereon.

Hereinafter, embodiments according to the present disclosure will be described in detail with reference to the accompanying drawings.

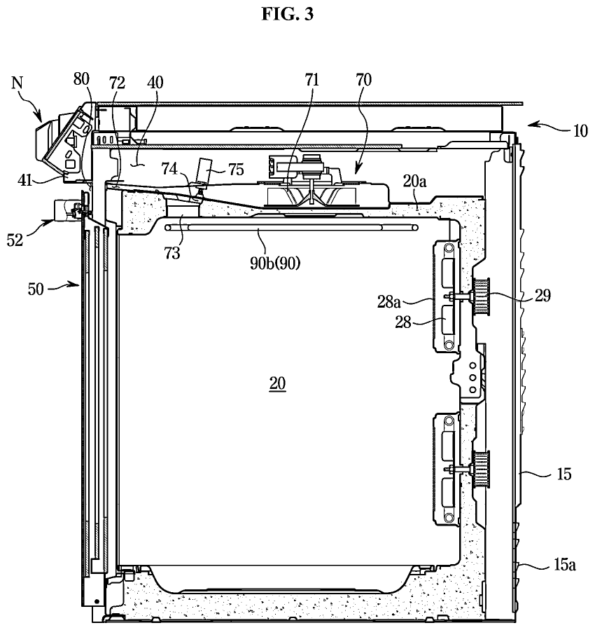

FIG. 1 is a perspective view of a cooking apparatus 1 according to an embodiment of the present disclosure. FIG. 2 is a front view of the cooking apparatus 1 illustrated in FIG. 1. FIG. 3 is a cross-sectional view of the cooking apparatus 1 illustrated in FIG. 1 taken along line III-III′.

An inner housing 11 and an outer housing 12 may have an approximately box-shape with an open front, respectively.

A cooking apparatus 1 may include a cooktop 30 provided on the top of the cooking apparatus 1 and heating a container containing food and placed thereon. The cooktop 30 may include at least one heating element 90a. A container containing food may be placed on the heating element 90a and directly heated.

The cooking apparatus 1 may include a door 50 provided on the front of a housing 10 to open and close a cooking chamber 20.

The outer housing 12 may include a front panel 13 forming the front of the housing 10, side panels 14 forming sides of a main body, and a rear panel 15 forming the rear of the housing 10.

The front panel 13 may have an opening, and the front of the cooking chamber 20 provided inside the housing 10 may be open through the opening. The outer housing 12 may include a control panel 41 located on an upper area of the front panel 13 and covering the front of a machine room 40. A display module 60 may be mounted on the control panel 41.

The control panel 41 may be arranged on at least a portion of the housing 10. According to an embodiment of the present disclosure, the control panel 41 may be located at an area of the front of the housing 10. However, the embodiment is not limited thereto, and the control panel 41 may be disposed on the top of housing 10 or constitute one surface of the housing 10.

Alternatively, the housing 10 may include the control panel 41.

An inlet 15a may be provided at the rear panel 15 to draw air into the machine room 40. Air drawn into the machine room 40 through the inlet 15a may cool electrical components while flowing inside the machine room 40. However, the position of the inlet 15a is not limited thereto and may be any position as long as external air is drawn in and guided to the machine room 40.

The cooking chamber 20 may be formed by a top plate 21, a bottom plate 22, two side plates 23, and a rear plate 24. The front of the cooking chamber 20, as a cooking space, may be open through the opening of the front panel 13 to allow food to be taken in and out.

A plurality of supports 25 may be provided on the inner side of the two side plates 23. At least one detachable rack 26 where food is placed may be mounted on the plurality of supports 25.

A rail (not shown) may be installed on the plurality of supports 25 to allow the rack 26 to slidably move. A user may take food out or place food by moving the rack 26 via the rail (not shown).

A divider (not shown) to divide the cooking chamber 20 into a plurality of spaces may be detachably mounted on the plurality of supports 25. The spaces of the cooking chamber 20 divided by the divider do not necessarily have the same size and may have different sizes.

As a result, the user may use the multiple spaces of the cooking chamber 20 divided according to user's intention in various ways. The divider may be formed of an insulating material to insulate the spaces of the cooking chamber 20.

A heater 90b for heating food may be provided in the cooking chamber 20. The heater 90b may be an electric heater including an electric resistor. However, the heater 90b is not limited thereto but may be a gas heater generating heat by burning gas. That is, the cooking apparatus 1 may include an electric oven and a gas oven.

The cooking apparatus 1 may include a heat source 90. The heat source 90 may be configured to heat food.

The heat source 90 may include the heating element 90a and the heater 90b, both described above.

A circulation fan 28 configured to circulate air of the cooking chamber 20 to heat food evenly and a circulation motor 29 configured to drive the circulation fan 28 may be provided at the rear plate 24 of the cooking chamber 20.

A fan cover 28a to cover the circulation fan 28 may be provided on the front of the circulation fan 28, and the fan cover 28a may have outlet holes 28b through which air flow.

The open front of the cooking chamber 20 is opened and closed by the door 50, and the door 50 may be coupled to the housing 10 by a hinge 51 rotatable relative to the housing 10 and provided at a lower region of the housing 10.

A handle 52 grasped by the user to open and close the door 50 for opening and closing of the cooking chamber 20 may be provided at an upper region of the front of the door 50.

A display module 60 configured to display information on various operations of the cooking apparatus 1 and allow the user to input an operation instruction may be mounted at the control panel 41 provided at an upper region of the front of the front panel 13.

The display module 60 may include a liquid crystal display (LCD), and the liquid crystal display may display electrical information about a change in transmittance of liquid crystals obtained by an applied voltage, as visual information. The liquid crystal display may include a liquid crystal module that displays an image, and a light source unit emitting light to the liquid crystal module, wherein a light-emitting diode (LED) may be used as the light source unit.

The display module 60 may include a cover panel 61 provided in front of the liquid crystal display. The cover panel 61 may be a protective panel simply protecting the liquid crystal display, but may also be a touch panel configured to receive a touch command of the user.

A knob assembly N configured to operate the cooking apparatus 1 may be provided at the control panel 41. According to an embodiment of the present disclosure, 4 knob assemblies N may be provided. However, the embodiment is not limited thereto. The knob assembly N will be described below in more detail.

A heat insulation material 20a that insulates the machine room 40 and the cooking chamber 20 may be disposed between the machine room 40 and the cooking chamber 20 to prevent heat of the cooking chamber 20 from being transferred to the machine room 40.

Not only between machine room 40 and the cooking chamber 20, the heat insulation material 20a may also cover the entire surface of the outside of the cooking chamber 20 to prevent heat of the cooking chamber 20 from being transferred to the outside of the cooking apparatus 1.

Because the temperature of the inside of the machine room 40 may be increased by heat of various electrical components, the cooking apparatus 1 may include an air blower 70 that cool the machine room 40 by circulating air around the machine room 40.

The air blower 70 may include a blower fan 71 that circulates air, and a discharge flow channel 72 provided to discharge the air, drawn by the blower fan 71, in the forward direction of the cooking apparatus 1.

The blower fan 71 may draw in air in the axial direction and then discharge the air in the radial direction. That is, the blower fan 71 according to the present disclosure may be a centrifugal fan. Alternatively, the blower fan 71 may include an axial-flow fan.

External air may be drawn into the machine room 40 through the inlet 15a formed at the rear panel 15, and the air drawn into the machine room 40 may cool the electrical components while flowing inside the machine room 40, and then flow along the discharge flow channel 72 to be discharged through the outlet 80 in the forward direction of the cooking apparatus 1.

The outlet 80 may have a space between the front panel 13 and the control panel 41. However, the embodiment is not limited thereto, the outlet 80 may be disposed at various positions and have various shapes, as long as the air introduced through the inlet 15a is discharged out of the main body.

The air inside the cooking chamber 20 may partially be drawn into the discharge flow channel 72 through a cooking chamber flow channel 73 and discharged through the front of the cooking apparatus 1.

The discharge flow channel 72 may have a bypass hole 74 allowing air, which flows from the discharge flow channel 72 to the outlet 80, partially to be introduced into the cooking chamber flow channel 73, and the bypass hole 74 may be opened or closed by an opening-closing device 75.

Because a volume of air introduced into the cooking chamber flow channel 73, as a part of the air flowing from the discharge flow channel 72 to the outlet 80, is controlled by opening and closing the bypass hole 74 using the opening-closing device 75, the volume of air discharged from the cooking chamber 20 to the cooking chamber flow channel 73 may be adjusted.

The door 50 rotatably coupled to the front of the housing 10 to open and close the cooking chamber 20 may include a plurality of glasses. A space may be formed between the plurality of glasses, and heat may be dissipated from the door 50 as external air is introduced into and circulate in the space.

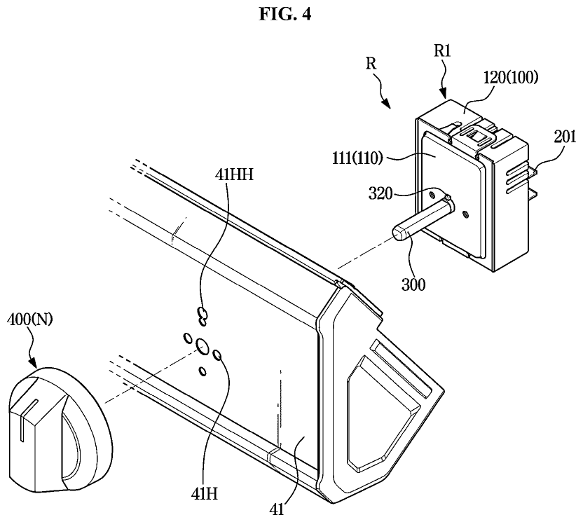

FIG. 4 is an enlarged view illustrating a portion of the cooking apparatus 1 shown in FIG. 1 where a knob assembly N is located.

The cooking apparatus 1 may include a knob assembly N. The knob assembly N may be configured to receive a user input to control the heat source 90 of the cooking apparatus 1.

The cooking apparatus 1 may include the housing 10 including the control panel 41.

The knob assembly N may be coupled to the control panel 41.

The knob assembly N may include a knob 400 located at one side of the control panel 41. The knob 400 may be configured to be grasped by the user and the user may input a user input thereby.

The knob 400 may be located in front of the control panel 41. Therefore, the knob 400 may be exposed to the user.

The knob 400 may be turned with respect to the control panel 41. The knob 400 may be turned about an axis. The user may input a user input by turning the knob 400.

The knob 400 may have a portion with a substantially cylindrical shape. The portion of the knob 400 having the cylindrical shape may be accommodated in the control panel 41. As a result, the knob 400 may be turned.

The knob 400 may have a portion extending in a direction and protruding forward so that the user may easily grasp the knob 400. The user may grasp the portion of the knob 400 extending in a direction of the knob 400 and protruding forward and turn the knob 400.

The knob 400 may include a plastic material. However, the embodiment is not limited thereto.

The knob 400 may be formed by an injection molding process. However, the embodiment is not limited thereto.

The knob 400 may have a shaft mounting hole 400H. The shaft mounting hole 400H may be a hole into which a shaft 300 of the regulator device R, which will be described below, is inserted.

The shaft mounting hole 400H may extend along the rotation axis of the knob 400.

The knob 400 may be coupled to the shaft 300 to be movable together with the shaft 300.

The knob assembly N may include the regulator device R. The regulator device R may be configured to generate a signal by the user input received by the knob 400.

The regulator device R may detect a user input to operate the heat source 90.

The regulator device R may be coupled to the knob 400. At least a portion of the regulator device R may be located behind the control panel 41. Thereby, exposure of the regulator device R to the user may be prevented.

The regulator device R may include a case 100. The case 100 may be configured to define at least one portion of the exterior appearance of the regulator device R.

The case 100 may have a substantially cuboidal shape.

The regulator device R may include a regulator body R1. The regulator body R1 may be an element constituting the rest of the regulator device R other than the shaft 300 which will be described below.

The regulator body R1 may be fitting-coupled to at least a portion of the shaft 300.

The regulator body R1 may have a substantially cuboidal shape. However, the embodiment is not limited thereto.

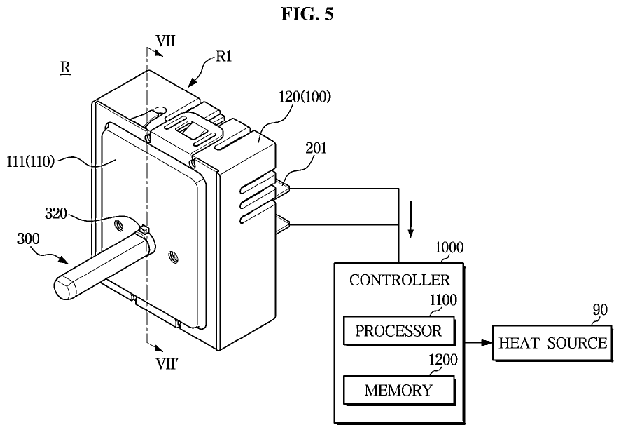

The regulator body R1 may transmit a signal to a processor (FIG. 5) by the flow of electricity. Based on the signal generated by the regulator body R1, the processor may generate a signal to operate the heat source 90.

The regulator body R1 may be located adjacent to the control panel 41. The regulator body R1 may be located opposite to the knob assembly N with the control panel 41 therebetween.

The regulator body R1 may be located to operate the heat source 90 and to be adjacent to the control panel 41.

The regulator body R1 may be located to face one side of the control panel 41.

The knob assembly N may be located on the other side of the control panel 41 and may be coupled to the shaft 300.

The regulator device R may include the shaft 300. The shaft 300 may be configured to be rotatably inserted into the case 100.

The shaft 300 may be coupled to the knob 400. The shaft 300 may be rotated together with the turning of the knob 400. The shaft 300 may be inserted into the shaft mounting hole 400H. Therefore, the user may turn the knob 400, and the turning of the knob 400 is transmitted to the shaft 300. As the shaft 300 is rotated thereby, the regulator may generate a signal.

The shaft 300 may extend along the rotation axis of the knob 400.

The shaft 300 may be located to penetrate the control panel 41. A portion of the shaft 300 penetrating the control panel 41 and located in front of the control panel 41 may be coupled to the knob 400. A portion of the shaft 300 located behind the control panel 41 may be coupled to the case 100.

The shaft 300 may be located at a first shaft position, where rotation with respect to the regulator body R1 is restricted. The shaft 300 may be coupled to the regulator body R1 to move a second shaft position, where rotation with respect to the regulator body R1 is possible, to operate the heat source 90.

The shaft 300 may include a shaft body. The shaft body may be a component defining at least a portion of the exterior appearance of the shaft 300.

The shaft body may include a knob mount 211. The knob mount 211 may be a component coupled to the knob 400.

The knob mount 211 may have a non-rotationally symmetric configuration. The knob mount 211 may be accommodated in the shaft mounting hole 400H. The shaft mounting hole 400H may have a shape corresponding to the knob mount 211. Therefore, the knob mount 211 may be turned in accordance with turning of the knob 400.

The case 100 may have a regulator screw hole 101H. The screw hole may be a hole at which a screw is installed.

The control panel 41 may have a panel screw hole 41H. The panel screw hole 41H may be a hole provided at a position corresponding to the regulator screw hole 101H.

A fastening member may combine the control panel 41 and the regulator device R by penetrating the panel screw hole 41H and the regulator screw hole 101H.

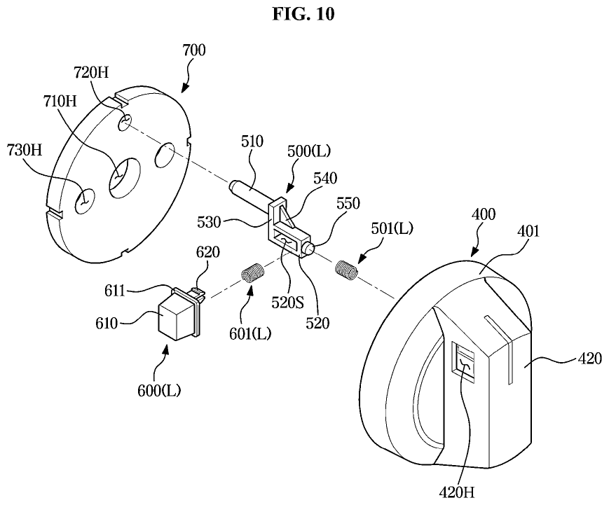

The control panel 41 may have a locking hole 41HH. The locking hole 41HH may be a hole into which a locker 500 (FIG. 10) described below may be inserted. The locking hole 41HH may be located to correspond to the locker 500.

Hereinafter, the regulator device R will be described in more detail.

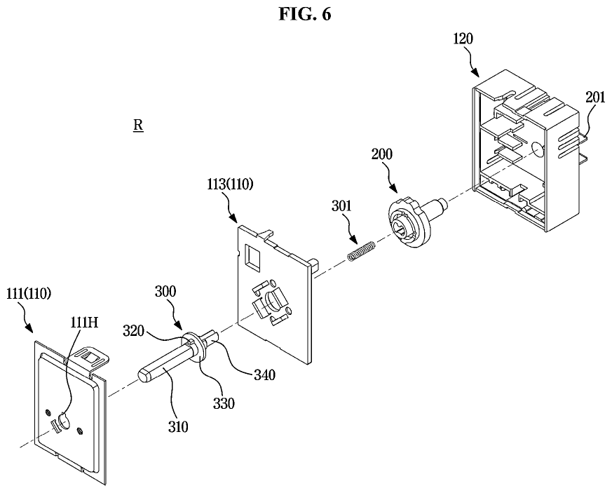

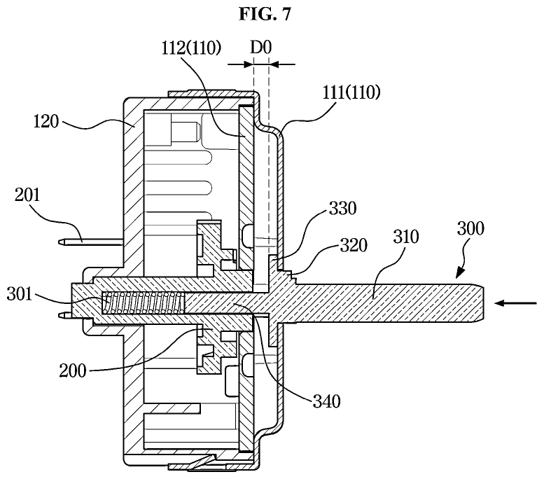

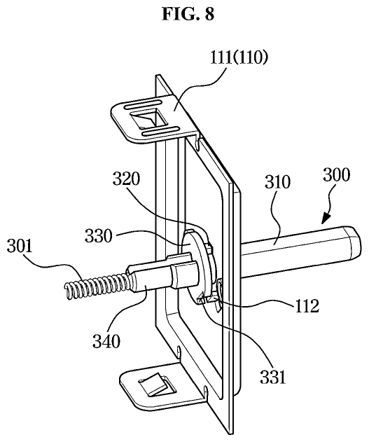

FIG. 5 is a perspective view illustrating the regulator device R shown in FIG. 4. FIG. 6 is an exploded perspective view of the regulator device R shown in FIG. 5. FIG. 7 is a cross-sectional view of the regulator device R shown in FIG. 5 taken along line VII-VII′. FIG. 8 is a rear perspective view illustrating that the shaft 300 is inserted into the outer cover 111 of the regulator device R shown in FIG. 6.

Referring to FIGS. 5 to 8, the regulator device R according to an embodiment of the present disclosure will be described.

The cooking apparatus 1 may include a controller 1000.

The controller 1000 may include a processor 1100 and a memory 1200.

The processor 1100 may include programs (plurality of instructions) configured to process a signal and provide a control signal.

The memory 1200 may include a volatile memory such as Static Random Access Memory (S-RAM) and Dynamic Random Access Memory (D-RAM), and a non-volatile memory such as Read Only Memory (ROM) and Erasable Programmable Read Only Memory (EPROM).

The memory 1200 may be integrated with the processor 1100 or may be provided as a semiconductor device separated from the processor 1100.

The processor 1100 may include a processing core (e.g., memory circuit and control circuit) configured to process the signal based on programs or data stored in the memory 1200 and output a control signal.

In the case where a first terminal (not shown) is in contact with a second terminal (not shown), the regulator device R may generate a signal received by the processor 1100.

The processor 1100 may control the heat source 90 to operate based on a user input detected by the regulator device R.

The processor 1100 may control the heat source 90 to operate based on a signal generated by the regulator device R in response to the user input.

However, the shaft 300 may be located at the second shaft position to rotate a cam 200 in accordance with the rotation of the shaft 300.

In the case where the shaft 300 is located at the first shaft position, a stopper 320 (FIG. 5) is accommodated in a stopper groove 111H (FIG. 5) restricting rotation of the shaft 300.

Therefore, only after the shaft 300 moves from the first shaft position to the second shaft position, the regulator device R may operate.

The cooking apparatus 1 may include the regulator device R.

The regulator device R may include the regulator body R1. The regulator body R1 may include the case 100. The regulator body R1 may include the cam 200. The regulator body R1 may include terminals 201.

The regulator device R may include the case 100.

The case 100 may include a case body 120. The case body 120 may be an element defining at least a portion of the exterior appearance of the case 100.

In the case where the case 100 has a cuboidal shape, the case body 120 may define 5 sides of the cuboid.

The case body 120 may have an operating space inside. The operating space may be a space surrounded by 5 sides of the case body 120. The operating space may have an opening.

The opening of the operating space may be located to face forward.

Components described below may be accommodated in the case 100 through the opening of the operating space.

The case body 120 may include a plastic material. However, the embodiment is not limited thereto.

The case body 120 may be formed by injection molding. However, the embodiment is not limited thereto.

The case 100 may include a case cover 110. The case cover 110 may be configured to close the opening of the operating space.

The case cover 110 may be located adjacent to the case body 120. The case cover 110 may be configured to close the operating space defined by the case body 120.

The case cover 110 may include an inner cover 113.

In the case where the case 100 has a cuboidal shape, the inner cover 113 may define one remaining side other than the 5 sides defined by the case body 120.

The inner cover 113 may be located in front of the case body 120.

The inner cover 113 may have a flat plate shape with a certain thickness. However, the embodiment is not limited thereto.

The inner cover 113 may include a plastic material. However, the embodiment is not limited thereto.

The inner cover 113 may be formed by injection molding. However, the embodiment is not limited thereto.

The case cover 110 may include an outer cover 111. The outer cover 111 may be located at an outer position of the inner cover 113 in the case 100.

The outer cover 111 may cover the inner cover 113. The outer cover 111 may be configured to correspond to the inner cover 113.

The outer cover 111 may be located in front of the inner cover 113.

The outer cover 111 may have a flat plate shape with a certain thickness. However, the embodiment is not limited thereto.

The outer cover 111 may include a metallic material. The outer cover 111 may be more rigid than the case body 120. However, the embodiment is not limited thereto.

The outer cover 111 may be formed by a press process. However, the embodiment is not limited thereto.

The outer cover 111 may have a shaft hole 710H. The shaft 300 may penetrate through the shaft hole 710H.

The shaft hole 710H may have a shape allowing the shaft 300 to pass through. For example, in the case where the cross-section of the shaft 300 is circular, the shaft hole 710H may be provided to have a cylindrical shape.

The shaft hole 710H may have a shape corresponding to the cross-sectional shape of the shaft 300. For example, the shaft hole 710H may have a cylindrical shape having a similar diameter to that of the cross-section of the shaft 300. In this regard, the similar diameter may mean that the shaft hole 710H has a tolerance in the cross-sectional shape of the shaft 300 to the extent that the shaft 300 moves through the shaft hole 710H.

The shaft hole 710H may be located at the center of gravity of the case cover 110. That is, in the case where the case cover 110 has a substantially cuboidal shape, the shaft hole 710H may be located at a position corresponding to the diagonal center.

The outer cover 111 may have a stopper groove 111H. The case 100 may have the stopper groove 111H. The stopper groove 111H may be a groove into which the stopper 320 of the shaft 300, which will be described below, is inserted.

The stopper groove 111H may be located at the case cover 110.

The case 100 may have a stopper groove 111H.

The stopper groove 111H may extend from in the shaft hole 710H. The stopper groove 111H may extend in the shaft hole 710H in the radial direction.

The stopper groove 111H may have a shape corresponding to the stopper 320. The stopper 320 may be accommodated in the stopper groove 111H. In the case where the stopper 320 is accommodated in the stopper groove 111H, movement of the stopper 320 is restricted, and rotation of the shaft 300 may be inhibited. More detailed descriptions will be given below in the description of the stopper 320.

However, the embodiment is not limited thereto, and the stopper 320 may be located at the case cover 110 and the stopper groove 111H may be located at the shaft 300. Hereinafter, for the convenience of description, the stopper 320 as an element of the shaft 300 and the stopper groove 111H located at the case cover 110 will be described.

The regulator device R may include the shaft 300. The shaft 300 may be rotatable with respect to the case 100.

The shaft 300 may extend in the forward-backward direction.

The shaft 300 may have a columnar shape with an approximate circular cross-section.

The shaft 300 may be located through the case cover 110. The shaft 300 may move inward along the extending direction of the shaft 300.

The shaft 300 may include a metallic material. As a result, the shaft 300 may have rigidity preventing breakage caused by translational motion or rotational motion. However, the embodiment is not limited thereto.

The shaft 300 may be formed by a casting process. However, the embodiment is not limited thereto.

The shaft 300 may include a shaft body 310. The shaft body 310 may define at least a portion of the exterior appearance of the shaft 300.

At least a portion of the shaft body 310 may be inserted into the case 100.

The shaft 300 may include a stopper 320. The stopper 320 may be configured to prevent the shaft 300 from rotating.

The stopper 320 may protrude from the shaft body 310. The stopper 320 may be accommodated in the stopper groove 111H. While the stopper 320 is accommodated in the stopper groove 111H, the stopper 320 may be in contact with the outer cover 111 so as to block rotation of the shaft 300.

The stopper 320 may have a shape corresponding to the stopper groove 111H. The stopper 320 may have a similar shape to that of the stopper groove 111H. That is, in the case where the stopper 320 has a quadrangular cross-section, the cross-section of the stopper groove 111H may have a quadrangular shape. Although the cross-section of the stopper 320 corresponds to the cross-section of the stopper groove 111H, there may be a tolerance allowing the stopper 320 to pass through the stopper groove 111H.

While the shaft 300 is located at the first shaft position, the stopper 320 may protrude from the shaft body 310 to be accommodated in the stopper groove 111H. While the shaft 300 is located at the second shaft position, the stopper 320 may be disengaged from the stopper groove 111H.

The shaft 300 may include a shaft flange 330. The shaft flange 330 may be brought into contact with the inner cover 113 or the outer cover 111 in the case where the shaft 300 moves in the forward and backward direction.

The shaft flange 330 may protrude from the shaft body 310 in the radial direction. The shaft flange 330 may extend from the shaft body 310 in the circumferential direction.

The shaft flange 330 may have a substantial disc shape.

In the case where the shaft 300 moves forward, the shaft flange 330 is brought into contact with the outer cover 111, so as to block dislocation of the shaft 300 in the forward direction may be prevented.

The shaft flange 330 may have a groove stopper 331. The groove stopper 331 may prevent rotation of the shaft 300 when the shaft 300 is located at the first shaft position.

The groove stopper 331 may be located at the shaft flange 330.

The groove stopper 331 may be configured to be recessed toward the rotation axis of the shaft 300 from the outer circumference surface of the shaft flange 330.

The groove stopper 331 may have a structure accommodating a groove stopper holder 112.

The groove stopper holder 112 may be included in the outer cover 111. The groove stopper holder 112 may protrude backward. The groove stopper holder 112 may protrude toward the inner cover 113.

The groove stopper holder 112 may have a shape corresponding to the groove stopper 331.

In the case where the shaft 300 is located at the first shaft position, the groove stopper holder 112 may be accommodated in the groove stopper 331. As a result, when the user tries to rotate the shaft 300 located at the first shaft position, the rotation of the shaft 300 may be restricted because the groove stopper holder 112 is brought into contact with the shaft flange 330.

In the case where the shaft 300 is located at the second shaft position, the groove stopper holder 112 may be disengaged from the groove stopper 331. Accordingly, when the user tries to rotate the shaft 300 located at the second shaft position, the groove stopper holder 112 may conduct turning movement without any component in contact therewith.

Dislocation of the shaft 300 backward may be prevented by the case 100.

In the case where the shaft 300 moves backward, the shaft flange 330 is brought into contact with the inner cover 113 to prevent dislocation of the shaft 300 backward.

Therefore, the shaft flange 330 may prevent dislocation of the shaft 300 from the case 100.

The shaft 300 may be located at the first shaft position. As the shaft 300 is located at the first shaft position, the stopper 320 may be accommodated in the stopper groove 111H. That is, the stopper 320 may protrude from the shaft body 310 to be accommodated in the stopper groove 111H as the shaft 300 is located at the first shaft position.

The shaft 300 may be located at the second shaft position. In the case where the shaft 300 is located at the second shaft position, the stopper 320 may be spaced apart from the stopper groove 111H by an operating distance.

While the shaft 300 is located at the second shaft position, the cam 200 rotates together with the shaft 300, so that the regulator device R may detect a user input. The cam 200 may be located adjacent to the shaft 300 allowing the shaft 300 to be inserted thereinto.

The shaft 300 may include a rotation inhibitor 340. The rotation inhibitor 340 may be rotated together with the cam 200 in the case of being accommodated in the cam 200.

The rotation inhibitor 340 may not have a symmetrical shape with respect to the rotation axis. The rotation inhibitor 340 may not have a cylindrical shape. For example, the rotation inhibitor 340 may have a shape cut along a plane including an extending direction of a cylinder.

Because the rotation inhibitor 340 may be rotated together with the cam 200, the shaft 300 may be rotated together with the cam 200. As a result, the regulator device R may output a signal corresponding to the user input.

The regulator device R may include the cam 200. The cam 200 may receive the rotational force from the shaft 300.

The cam 200 may be rotated together with the shaft 300.

The cam 200 may be provided at the case body 120 to be rotatable. Accordingly, the cam 200 may rotate while being supported by the case body 120.

The cam 200 may have a plastic material. However, the embodiment is not limited thereto.

The cam 200 may be formed by an injection molding process. However, the embodiment is not limited thereto.

The regulator device R may include a terminal 201. The terminal 201 may be an element allowing electricity to flow.

The terminal 201 may include a first terminal and a second terminal.

While the first terminal is in contact with the second terminal in accordance with the rotation of the cam 200, the regulator device R may generate a signal based on the user input.

The regulator device R may include a shaft elastic member 301. The shaft elastic member 301 may be an element pressing the shaft 300 forward.

The shaft elastic member 301 may be located between the shaft 300 and the cam 200.

The shaft elastic member 301 may be an element pressing the shaft 300 such that the stopper 320 is located in the stopper groove 111H. The shaft elastic member 301 may press the rotation inhibitor 340. The shaft elastic member 301 may be in contact with the rotation inhibitor 340. As being pressed by the shaft 300, the shaft elastic member 301 may press the shaft 300 in the opposite direction.

By pressing and rotating the shaft 300, the user may generate a signal in the regulator device R. In order to stop the generation of the signal in the regulator device R, the user may remove the pressure applied to the shaft 300 to restore the shaft 300 to the original position thereof.

For example, the shaft elastic member 301 may include a compression spring.

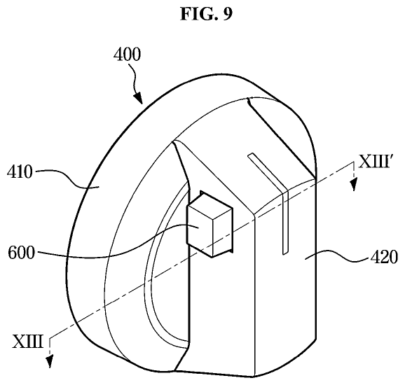

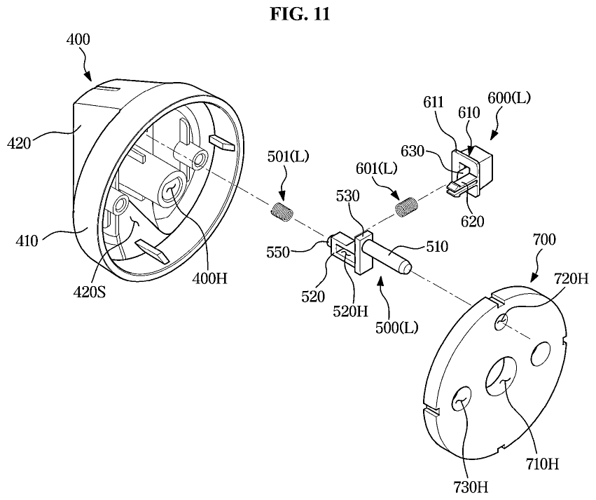

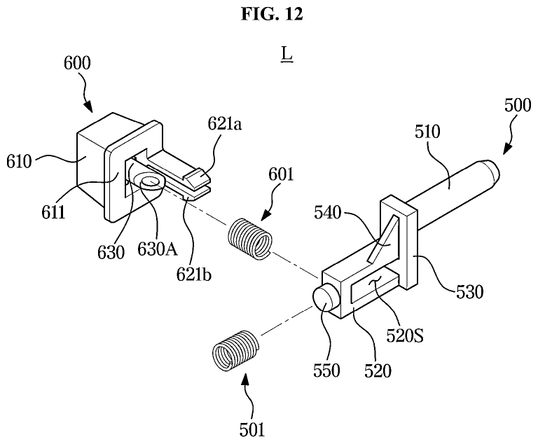

FIG. 9 is a perspective view of the knob assembly N illustrated in FIG. 4. FIG. 10 is an exploded view of the knob assembly N illustrated in FIG. 9. FIG. 11 is an exploded view of the knob assembly N illustrated in FIG. 10 viewed at another angle. FIG. 12 is an exploded view of a locking device L illustrated in FIG. 10.

Referring to FIGS. 9 to 12, the knob assembly N according to an embodiment of the present disclosure will be described.

The knob assembly N may include a knob 400. The knob 400 may define the exterior appearance of the knob assembly N.

The knob 400 may be grasped by the user.

The user may operate the cooking apparatus 1 by grasping the knob 400 and then pressing or rotating the knob 400.

The knob 400 may have a space inside to accommodate other components. The knob 400 may have an opening inside to accommodate other components.

The knob 400 may be located in front of other components accommodated therein to cover the components.

The knob 400 may include a plastic material. However, the embodiment is not limited thereto.

The knob 400 may be formed by injection molding. However, the embodiment is not limited thereto.

The knob 400 may include a knob body 410.

The knob body 410 may have a substantially cylindrical shape.

The knob body 410 may have a locking device mounting space 420S inside. The locking device mounting space 420S may be a space in which at least a portion of the locking device L described below is accommodated.

At least a portion of the locking device mounting space 420S may be defined by the knob body 410. The locking device mounting space 420S may be a apace formed between the knob 400 and a weight 700.

The knob body 410 may have a button exposure hole 420H. The button exposure hole 420H may be a hole through which at least a portion of a button 600 passes.

The button exposure hole 420H may be located at a side of the knob body 410.

At least a portion of the button 600 may be exposed to the outside of the knob 400 through the button exposure hole 420H therethrough. The user may press the button 600.

The button exposure hole 420H may be connected to the locking device mounting space 420S.

The knob 400 may include a knob-grasping area 420.

The knob-grasping area 420 may protrude from the knob body 410.

The knob-grasping area 420 may have a substantially cuboidal shape.

The knob-grasping area 420 may be formed not to extend beyond the outer circumference of the knob body 410. That is, a long side of the knob-grasping area 420 may have a length equal to or less than a diameter of the knob body 410.

A button holder described below may be accommodated in a space defined by the knob-grasping area 420.

The knob 400 may include a button movement-restricting component 421.

The button movement-restricting component 421 may extend toward the control panel 41 from the knob-grasping area 420.

The button movement-restricting component 421 may be brought into contact with the locker 500 described below to prevent a movement of the locker 500 from a locking position to a unlocking position.

In the case where the button 600 is located at a second button position, the button movement-restricting component 421 may be brought into contact with the button 600, so that the entire button 600 is accommodated in the locking device mounting space 420S, thereby preventing the button 600 from returning to a first button position.

The knob 400 may have an elastic member insertion area.

The knob assembly N may include the weight 700. The weight 700 may cover the opening of the knob 400.

The weight 700 may be located adjacent to the knob body 410.

The weight 700 may have a shape corresponding to the knob body 410. The weight 700 may have a substantially cylindrical shape.

The weight 700 may include a metallic material. Thus, the user may feel the weight of the knob assembly N. However, the embodiment is not limited thereto.

The weight 700 may be formed by casting.

The weight 700 may have a shaft hole 710H. The shaft hole 710H may be a hole through which the shaft 300 passes.

The shaft hole 710H may be located at a position corresponding to the center of a circle in the case where the weight 700 has a cylindrical shape.

The shaft hole 710H may have a diameter allowing the shaft 300 to pass therethrough.

The weight 700 may have a fastening member hole 730H. The fastening member hole 730H may be a hole through which the knob fastening member (not shown) passes.

The knob fastening member may combine the weight 700 with the knob 400.

The fastening member hole 730H may be provided in plural. The plurality of fastening member holes 730H may be located symmetrically with respect to the shaft hole 710H. Accordingly, the knob 400 may be engaged with the weight 700 horizontally.

The weight 700 may have a locker hole 720H. The locker hole 720H may be a hole through which the locker 500 passes.

The locker hole 720H may be located to correspond to the locker 500 described below. Therethrough, the locker 500 may be exposed to the outside of the locker hole 720H. A movement of the locker 500 between the unlocking position and the locking position may be guided by a surface defining the locker hole 720H.

The locker hole 720H may have a diameter allowing the locker 500 to pass therethrough.

The knob assembly N may include a locking device L. The locking device L may be a device configured to lock the movement of the knob 400.

At least a portion of the locking device L may be located between the locking device L and the weight 700.

The locking device L may restrict rotation of the knob assembly N.

The locking device L may be provided at the knob 400.

The locking device L may include the locker 500. The locker 500 may be a component configured to prevent the knob 400 from moving.

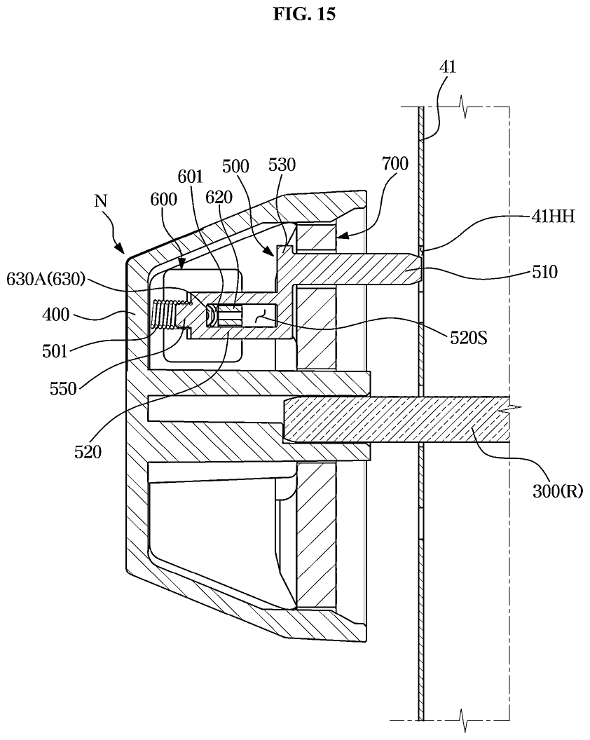

The locker 500 may extend in the forward-backward direction. The locker 500 may extend toward the control panel 41 (FIG. 15).

At least a portion of the locker 500 may be located between the knob 400 and the weight 700. At least a portion of the locker 500 may be exposed to the outside of the weight 700. At least a portion of the locker 500 may be exposed through the locking hole 41HH of the weight 700.

The locker 500 may move to the locking position and the unlocking position. While moving from the locking position to the unlocking position, the locker 500 may move in an extending direction of the locker 500.

While the shaft 300 is located at the second shaft position, the locker 500 may move to the locking position to be inserted into the control panel 41 to prevent the knob 400 from being turned. The locker 500 may move to the unlocking position to be disengaged from the control panel 41 allowing the knob 400 to be turned.

A moving distance (D2-D1) of the locker 500 from the locking position to the unlocking position may be greater than a moving distance (D0) of the shaft 300 from the first shaft position to the second shaft position.

The movement of the locker 500 will be described below in more detail with respect to the related drawings.

The locker 500 may include a plastic material. However, the embodiment is not limited thereto.

The locker 500 may be formed by injection molding. However, the embodiment is not limited thereto.

The locker 500 may include a locker support 520. The locker support 520 may be pressurized to allow the locker 500 to move.

The locker support 520 may be located between the weight 700 and the knob 400. The locker support 520 may move between the weight 700 and the knob 400 to cause a movement of the locker 500.

The locker support 520 may have a substantially cuboidal shape.

The locker support 520 may have a protrusion-accommodating space 520S inside edges. The locker support 520 may have the protrusion-accommodating space 520S in which a pressure-applying protrusion 630 is accommodated.

While the button 600 moves from the first button position to the second button position, the locker support 520 may move in a state of being pressed by a pressure-applying surface 630A.

The protrusion-accommodating space 520S may be a space to accommodate the pressure-applying protrusion 630 described below.

The protrusion-accommodating space 520S may have a cylindrical shape with a rectangular cross-section.

The locker 500 may include an elastic member guide 550. The elastic member guide 550 may guide the position of a locker elastic member 501 described below.

The elastic member guide 550 may extend toward the knob 400 from the locker support 520. The elastic member guide 550 may extend forward.

The elastic member guide 550 may have a substantially cylindrical shape.

The diameter of the elastic member guide 550 may be less than a length of one side of an adjacent locker support 520. As a result, the locker elastic member 501 may surround the elastic member guide 55 and be supported by the locker support 520.

The locking device L may include the locker elastic member 501. The locker elastic member 501 may be configured to apply an elastic force to the locker 500.

The locker elastic member 501 may be located between the locker support 520 and the knob 400. The locker elastic member 501 may press the locker support 520 in a direction away from the knob 400.

The locker elastic member 501 may be located between the knob 400 and the locker 500 such that the locker 500 located at the unlocking position is pressed toward the locking position.

The locker elastic member 501 may be, for example, a spring.

The locker 500 may include a locker contact component 510. The locker contact component 510 may be configured to be in contact with the control panel 41.

The locker contact component 510 may be configured to be accommodated in the locking hole 41HH of the control panel 41.

That is, the control panel 41 may be provided at a position corresponding to the locker 500 to accommodate the locker 500 while the locker 500 is located at the locking position.

The locker contact component 510 may pass through the locker hole 720H of the weight 700.

The locker contact component 510 may have a shape with a tapered end. Based thereon, the locker contact component 510 may be smoothly accommodated in the locking hole 41HH.

The end of the locker 500 facing the regulator body R1 may have a tapered shape to be inserted into the locking hole 41HH.

The locker 500 may include a locker extension 530. The locker extension 530 may be configured to connect the locker contact component 510 with the locker support 520.

The locker extension 530 may extend from the locker support 520 in a direction away from the shaft 300 (FIG. 15).

The locker contact component 510 may be located in a direction where the locker elastic member 501 presses. This is because it is preferable that a force applied by the locker elastic member 501 is transmitted to the locker contact component 510 without a torque. However, another component may be located between the control panel 41 and the weight 700. To avoid this, the position of the locker contact component 510 may need to be adjusted.

The elastic member guide 550 may be located adjacent to the knob-grasping area 420 of the knob 400. Because the knob-grasping area 420 protrudes forward from the knob body 410, it is easy to obtain a space for the movement of the locker 500. Therefore, the elastic member guide 550 and the locker support 520 extending from the elastic member guide 550 are located adjacent to the knob-grasping area 420, and the locker extension 530 may be configured to extend in a direction from the locker support 520 such that the position of the locker contact component 510 is separated from other components of the control panel 41. In addition, the locker contact component 510 may be configured to extend from the locker extension 530.

The locker 500 may include a support rib 540.

The support rib 540 may be configured to connect the elastic member guide 550 with the locker extension 530. Thus, the strength of the locker 500 may be enhanced.

The locking device L may include the button 600. The button 600 may be grasped by the user.

The button 600 may move from the first button position to the second button position.

The button 600 may be located at the first button position to restrict the movement of the locker 500 from the locking position to the unlocking position. The button 600 may move to the second button position to allow the locker 500 to move from the locking position to the unlocking position.

The button 600 may be located at the first button position unless the user presses the button 600.

In the case where the user presses the button 600, the button 600 may be located at the second button position.

While moving from the first button position to the second button position, the button 600 may move the locker 500 from the locking position to the unlocking position. As the locker 500 moves from the locking position to the unlocking position, the knob 400 may be turned. If the knob 400 is turned, the shaft 300 may be rotatable. If the shaft 300 is rotatable, the regulator device R may operate. That is, in the case where the button 600 is located at the second button position, the heat source 90 may operate.

The button 600 may include a plastic material. However, the embodiment is not limited thereto.

The button 600 may be formed by injection molding. However, the embodiment is not limited thereto.

The button 600 may include a button-grasping area 610. The button-grasping area 610 may be pressed by the user.

The button-grasping area 610 may be exposed to the outside of the knob 400. The button-grasping area 610 may be located through the button exposure hole 420H.

The button-grasping area 610 may be configured to pass through the button exposure hole 420H. A cross-sectional area of the button-grasping area 610 may be smaller than that of the button exposure hole 420H.

A movement of the button-grasping area 610 may be guided by the knob body 410 defining the button exposure hole 420H.

The button-grasping area 610 may have a substantially cuboidal shape.

The button-grasping area 610 may taper such that a cross-sectional area becomes narrower as it approaches the exposed end. As a result, the button 600 may be easily seated in the locking device mounting space 420S and the end may be easily exposed through the button exposure hole 420H.

The button 600 may include a support flange 611. The support flange 611 may extend in the radial direction from the opposite side of the portion of the button-grasping area 610 exposed to the outside.

The support flange 611 may prevent the button 600 from being separated from the knob 400. Upon an attempt to separate the button 600 from the knob 400, the support flange 611 in contact with the inner side of the knob-grasping area 420 may prevent the button 600 from being separated from the knob 400.

The support flange 611 may extend from the button-grasping area 610 outward from the button-grasping area 610 to prevent the button 600 from being separated from the knob 400. The pressure-applying protrusion 630 may extend in the button-grasping area 610.

In the case where the button 600 moves from the first button position to the second button position, the support flange 611 may guide the movement of the button 600 via interaction with the locker support 520.

The support flange 611 may include a lower support flange 611. The support flange 611 may prevent the button 600 from extending downward beyond the button hook 620 so as to insert the button 600 linearly into the protrusion-accommodating space 520S.

The button 600 may include a button hook 620. The button hook 620 may be configured to engage the button 600 with the locker 500.

The button hook 620 may extend from the support flange 611. Alternatively, the button hook 620 may extend from the button-grasping area 610. The button hook 620 may extend toward a portion facing a position, where the button exposure hole 420H of the knob-grasping area 420 is located.

The button hook 620 may have a hook shape at the end. By the hook shape, separation of the button 600 from the locker 500 may be prevented.

The button hook 620 may be located to penetrate the protrusion-accommodating space 520S.

The button hook 620 may extend through the protrusion-accommodating space 520S to guide the button 600.

The button hook 620 may include a first hook 621a and a second hook 621b.

The end of the first hook 621a may be spaced apart from the end of the second hook 621b. As a result, while the first hook 621a and the second hook 621b are engaged with the button 600 and the locker 500 after passing through the protrusion-accommodating space 520S, the end of the first hook 621a may be located adjacent to the end of the second hook 621b. When the first hook 621a and the second hook 621b are located after passing through the protrusion-accommodating space 520S, the end of the first hook may be located to be spaced apart from the end of the second hook 621b. As a result, the first hook 621a and the second hook 621b may pass through the protrusion-accommodating space 520S and prevent the button 600 from being separated from the locker 500.

The button 600 may include the pressure-applying protrusion 630. The pressure-applying protrusion 630 may be configured to press the locker 500.

The pressure-applying protrusion 630 may extend from the button-grasping area 610. The pressure-applying protrusion 630 may extend parallel to the extending direction of the button hook 620. The pressure-applying protrusion 630 may extend toward a portion facing a position, where the button exposure hole 420H of the knob-grasping area 420 is located.

While the button 600 moves from the first button position to the second button position, the pressure-applying protrusion 630 may press the locker 500 from the unlocking position to the locking position.

At least a portion of the pressure-applying protrusion 630 may be accommodated in the protrusion-accommodating space 520S. The pressure-applying protrusion 630 may press the locker 500 to allow the locker 500 to move from the unlocking position to the locking position.

The pressure-applying protrusion 630 may be in contact with the locker support 520. The pressure-applying protrusion 630 may be in contact with the locker support 520 located to face the protrusion-accommodating space 520S.

The pressure-applying protrusion 630 may have a pressure-applying surface 630A on the end. The pressure-applying surface 630A may be configured to be in contact with the locker support 520.

The pressure-applying surface 630A may be in contact with the locker 500.

The pressure-applying surface 630A may have a surface inclined toward the button-grasping area 610 as it is closer to the locker support 520. For example, the pressure-applying surface 630A may have a tapered shape. The pressure-applying surface 630A may be inclined toward the button-grasping area 610 as it goes forward. The pressure-applying surface 630A may be inclined as it is closer to the button exposure hole 420H as it goes forward.

The movement of the locker support 520 may be guided along the pressure-applying surface 630A. While the button 600 moves from the first button position to the second button position, the locker support 520 may move along the pressure-applying surface 630A. Accordingly, the locker 500 may move from the locking position to the unlocking position.

To allow the locker support 520 to move along the pressure-applying surface 630A, the pressure-applying surface 630A may be inclined.

The pressure-applying surface 630A may be inclined toward the control panel 41 in a direction from the first button position to the second button position of the button 600.

The pressure-applying surface 630A may substantially have an angle of 45 degrees or less. Therefore, the button 600 may easily move along the pressure-applying surface 630A.

The pressure-applying protrusion 630 may be located to be spaced apart from the button hook 620. A seating gap may be provided between the pressure-applying protrusion 630 and the button hook 620. A button elastic member 601 may be inserted into the seating gap.

The seating gap may be provided between the button hook 620 and the pressure-applying protrusion 630 to accommodate a portion of the elastic member such that the elastic member is mounted on the button 600.

The locking device L may include the button elastic member 601. The button elastic member 601 may press the button 600 to allow the button 600 to move from the second button position to the first button position.

In the case where the locker 500 is located at the unlocking position, the button elastic member 601 may be located between the locker 500 and the button 600 such that the button 600 is pressed from the second button position to the first button position.

The button elastic member 601 may be located between the support flange 611 and the locker support 520.

A portion of the button elastic member 601 may be located in the seating gap. Therefore, the position of the button elastic member 601 may be fixed.

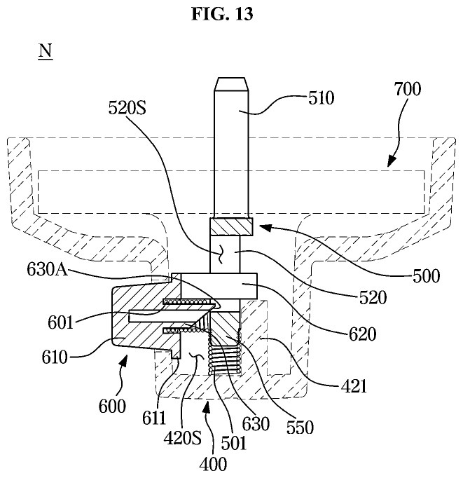

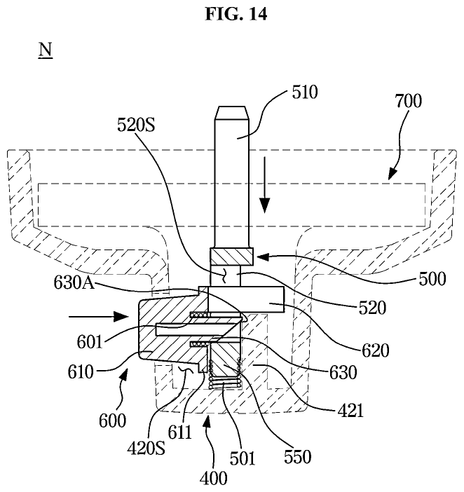

FIG. 13 is an exploded cross-sectional view of the knob assembly N illustrated in FIG. 9 taken along line VIII-VIII′ in which the button 600 is located at the first button position. FIG. 14 is an exploded cross-sectional view of the knob assembly N illustrated in FIG. 13 in which the button 600 is located at the second button position.

Referring to FIGS. 13 and 14, the movement of the locker 500 according to an embodiment of the present disclosure will be described.

The locker 500 may move to the locking position and the unlocking position.

The button 600 may move to the first button position and the second button position.

Referring to FIG. 13, when located at the locking position, the locker 500 may be exposed to the outside of the weight 700. That is, in the case where the locker 500 is located at the locking position, the locker contact component 510 may be exposed to the outside of the weight 700.

In the case where the locker 500 is located at the locking position, the locker elastic member 501 presses the locker 500, so that the locker contact component 510 may be exposed to the outside of the weight 700.

Movement of the button 600 outward from the knob 400 may be prevented at the first button position. This is because the support flange 611 of the button 600, in contact with the inner side of the knob 400, prevents the movement of the button 600.

When located at the first button position, the button 600 may be exposed to the outside of the knob 400.

Because the button elastic member 601 presses the button 600 from the second button position toward the first button position, the button 600 may be exposed to the outside of the knob 400 at the first button position. That is, in the case where the button 600 is located at the first button position, the button-grasping area 610 may be exposed to the outside of the knob 400.

Furthermore, in the case where the button 600 is located at the first button position, the locker elastic member 501 may press the locker 500 backward. While the locker 500 is pressed backward, the locker support 520 may press the pressure-applying protrusion 630 outward from the knob 400. This is because the locker support 520 is in contact with the pressure-applying surface 630A. While the locker support 520 is pressing the pressure-applying surface 630A, the force applied to by the locker support 520 may press the locker 500 outward from the knob 400 because the pressure-applying surface 630A is inclined.

Referring to FIG. 14, when located at the unlocking position, the locker 500 may be less exposed to the outside of the weight 700 than when located at the locking position. That is, in the case where the locker 500 is located at the unlocking position, the locker contact component 510 may move more inward into the knob 400 than when located at the locking position.

In the case where the locker 500 is located at the unlocking position, the movement inward into the knob 400 may be restricted due to a maximum compression distance of the locker elastic member 501.

At the second button position, the movement of button 600 inward into the knob 400 may be restricted. This is because the pressure-applying protrusion 630 of the button 600 is in contact with the button movement-restricting component 421 of the knob 400. Additionally, the support flange 611 of the knob 400 may press the locker support 520 of the locker 500 toward the button movement-restricting component 421 of the knob 400. Although the support flange 611 presses the locker support 520 toward the button movement-restricting component 421 of the knob 400, the movement of the locker 500 may be restricted because the button movement-restricting component 421 of the knob 400 is in contact with the locker support 520. Because the movement of the locker 500 restricted, the movement of the button 600 may be restricted.

The button 600 may be less exposed to the outside of the knob 400 at the second button position than when at the first button position. The button 600 may be more inserted into the knob 400 at the second button position than when at the first button position.

While the button 600 is pressed from the first button position to the second button position, the button 600 may press the locker 500 forward. While the locker 500 is pressed forward, the locker support 520 may be pressed by the pressure-applying surface 630A of the pressure-applying protrusion 630.

While the locker 500 moves from the locking position to the unlocking position, the locker support 520 may move forward in contact with the pressure-applying surface 630A. Because the pressure-applying surface 630A is inclined, the locker support 520 may move along the inclined pressure-applying surface 630A.

The movement of the button 600 from the first button position to the second button position may be a similar situation where the user pushes the button 600.

By the movement of the button 600 from the first button position to the second button position, the locker 500 may move from the locking position to the unlocking position.

The movement of the button 600 from the second button position to the first button position may be a similar situation where the user does not push the button 600.

By the movement of the button 600 from the second button position to the first button position, the locker 500 may move from the unlocking position to the locking position.

In this regard, the movement of the button 600 from the second button position to the first button position may be explained as a reverse process of the movement of the button 600 from the first button position to the second button position.

The above-described movement of the locker 500 will be described in connection with the locking hole 41HH of the control panel 41 (FIG. 15).

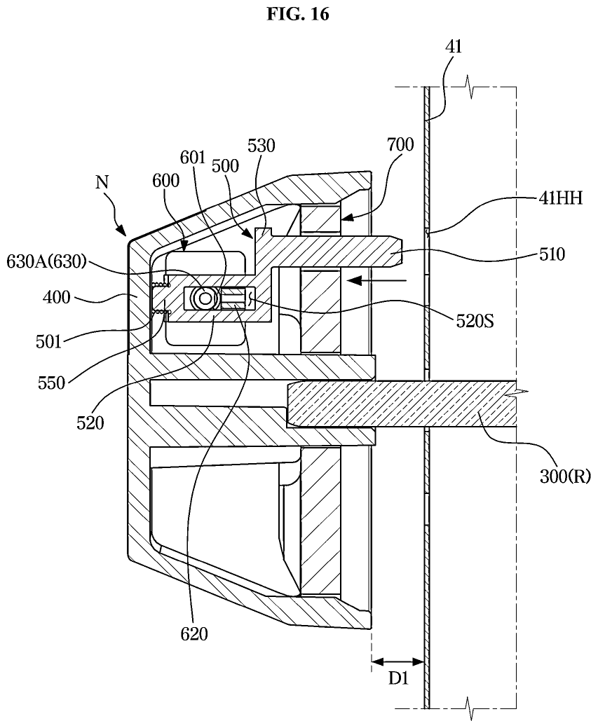

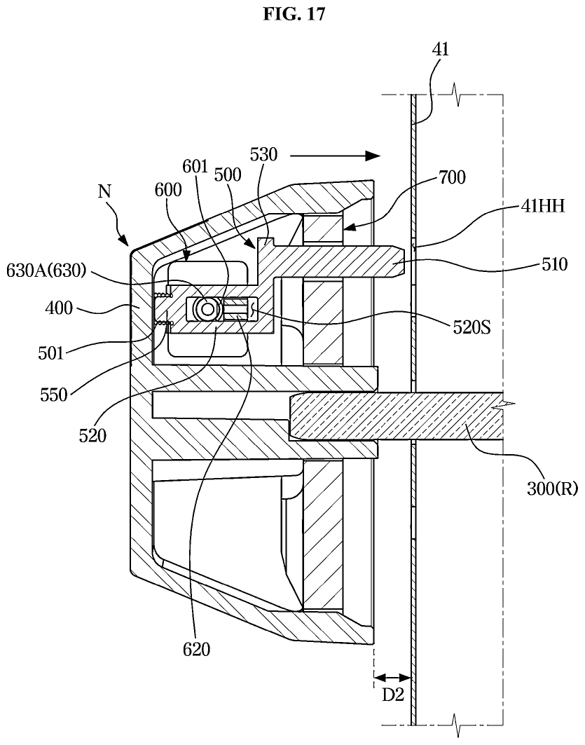

FIG. 15 is a cross-sectional view of the knob assembly N shown in FIG. 9 taken along line XV-XV′ shown in FIG. 2 in which the knob assembly N is mounted on the shaft 300 of the regulator device R in the case where the button 600 is located at the first button position. FIG. 16 is a cross-sectional view of the knob assembly N of FIG. 15 in the case where the button 600 is located at the second button position. FIG. 17 is a cross-sectional view of the knob assembly N of FIG. 16 in the case where the knob 400 moves from a first knob position to a second knob position.

Referring to FIGS. 15 to 17, movements of the knob assembly N and the regulator device R according to an embodiment of the present disclosure will be described.

As described above, while the button 600 moves from the first button position to the second button position, the locker 500 may move from the locking position to the unlocking position. While the locker 500 is located at the locking position, the turning of the knob 400 may be restricted. As the turning of the knob 400 is restricted, the rotation of the shaft 300 may be restricted.

The shaft 300 may rotate by moving from the first shaft position to the second shaft position. The regulator device R may operate the heat source 90 only when the shaft 300 is rotated. This is because the stopper 320 of the shaft 300 needs to be released from the stopper groove 111H.

The shaft 300 may be engaged with the knob 400. While the shaft 300 moves from the first shaft position to the second shaft position, the knob 400 may move from the first knob position to the second knob position.

For example, the position of the knob 400 illustrated in FIG. 15 may be considered as the first knob position. The position illustrated in FIG. 17 may be considered as the second knob position.

In the case where the knob 400 is located at the second knob position, the shaft 300 may be located at the second shaft position. In the case where the knob 400 is located at the second knob position, the knob 400 may be turned to rotate the shaft 300.

In the case where the turning of the knob 400 is restricted at the second knob position, the rotation of the shaft 300 may be restricted. In this case, the regulator device R may be difficult to operate the heat source 90.

The locker 500 may restrict the operation of regulator device R by restricting rotation of the knob 400

Referring to FIGS. 15 and 16, while the button 600 moves from the first button position to the second button position, the locker 500 may move from the locking position to the unlocking position.

When located at the locking position, the locker 500 may or may not be inserted into the locking hole 41HH. However, in the case where the locker 500 is inserted into the locking hole 41HH, and the knob 400 is located at the second knob position, as described below, a moving distance of the locker 500 increases for disengagement of the locker 500 from the locking hole 41HH. Thus, preferably, the locker 500 may not be inserted into the locking hole 41HH or only the end of the locker 500 may be inserted into the locking hole 41HH.

While the button 600 moves from the first button position to the second button position, the locker 500 may move from the locking position toward the unlocking position.

While the button 600 moves from the first button position to the second button position, the locker 500 may move forward.

While the button 600 moves from the first button position to the second button position, the locker contact component 510 may move in a direction away from the control panel 41.

Upon the movement of the button 600 to the second button position, the locker 500 may be disengaged from the locking hole 41HH.

Referring to FIG. 17, while the shaft 300 moves from the first shaft position to the second shaft position, the knob 400 may move from the first knob position to the second knob position.

While the knob 400 moves from the first knob position to the second knob position, the knob 400 may become closer to the control panel 41. While the knob 400 moves from the first knob position to the second knob position, the knob 400 may become closer to the locking hole 41HH.

While the knob 400 moves from the first knob position to the second knob position, the locker 500 may become closer to the locking hole 41HH. However, the locker 500 may not be inserted into the locking hole 41HH.

In the case where the locker 500 is inserted into the locking hole 41HH, the locker 500 may be brought into contact with the control panel 41 adjacent to the locking hole 41HH by an attempt to turn the knob 400. Accordingly, the turning of the knob 400 may be restricted. In the case where the rotation of the knob 400 is restricted, the rotation of the shaft 300 may be restricted. In the case where the turning of the knob 400 is restricted, the regulator device R may be difficult to operate the heat source 90.

In the case where the locker 500 is not inserted into the locking hole 41HH, the knob 400 may be turned. Accordingly, the regulator device R may operate the heat source 90.

That is, in the case where the button 600 is located at the second button position, the knob 400 may be turned and the regulator device R may operate the heat source 90.

Therefore, unless the button 600 is pressed, malfunction of the heat source 90 may be prevented. If the user intentionally presses the button 600, the heat source 90 may operate.

The cooking apparatus 1 according to an embodiment of the present disclosure is described above. Hereinafter, a cooking apparatus 1 according to another embodiment of the present disclosure will be described. The same components as those illustrated in FIGS. 1 to 17 are denoted by the same reference numerals, and detailed descriptions thereof will be omitted.

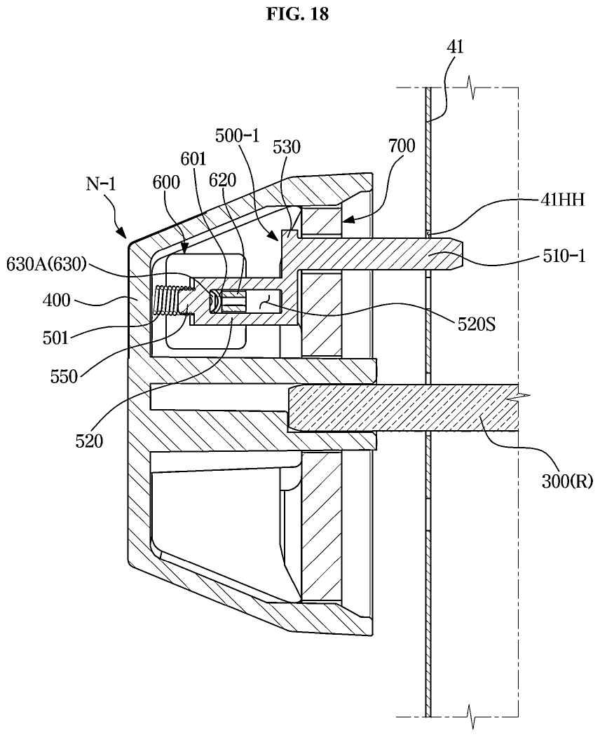

FIG. 18 is a cross-sectional view illustrating a knob assembly N-1 of a cooking apparatus 1 according to an embodiment of the present disclosure and components related thereto.

Referring to FIG. 18, a locker 500-1 according to an embodiment of the present disclosure will be described.

At a locking position, the locker 500-1 may pass through the locking hole 41HH to be inserted into the control panel 41.

While the knob 400 is located at the first knob position, the locker 500-1 may be located through the locking hole 41HH at the locking position.

The end of the locker 500 shown in FIGS. 1 to 17 may be accommodated in the locking hole 41HH while the knob 400 is located at the first knob position. In this case, the end of the locker 500 may not be located inside the control panel 41.

In this embodiment, the end of the locker 500-1 may be located through the locking hole 41HH at the locking position while the knob 400 is located at the first knob position. In this regard, the end of the locker 500-1 may be located inside the control panel 41.

In the case where the end of the locker 500-1 is located inside the control panel 41, the turning of the knob 400 may be restricted even while the knob 400 is located at the first knob position. Therefore, the user may recognize that it is difficult to operate the cooking apparatus 1 without pressing the button 600.

That is, while the button 600 is located at the first button position, a locker contact component 510-1 of the locker 500-1 may be inserted into the locking hole 41HH.

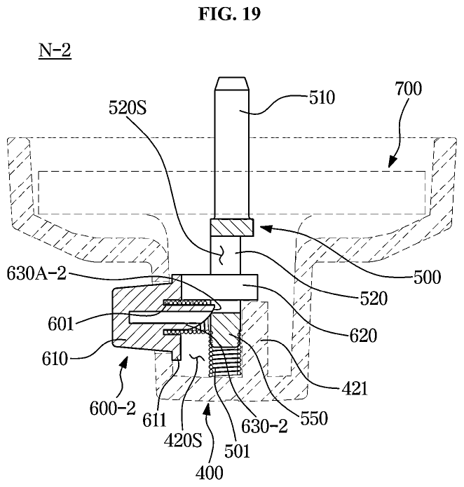

FIG. 19 is a cross-sectional view of a knob assembly N-2 of a cooking apparatus 1 according to an embodiment of the present disclosure.

Referring to FIG. 19, a button 600-2 according to an embodiment of the present disclosure will be described.

The button 600-2 may include a pressure-applying protrusion 630-2. The pressure-applying protrusion 630-2 may have a pressure-applying surface 630A-2.

The pressure-applying surface 630A-2 may be in contact with the locker 500. The pressure-applying surface 630A-2 may be in contact with the locker support 520 of the locker 500.

The pressure-applying surface 630A-2 may have a curvature. The center of curvature of the pressure-applying surface 630A-2 may be located in a direction toward the control panel 41. The pressure-applying surface 630A-2 may have a convex shape in a direction away from the control panel 41.

In the case where the pressure-applying surface 630A-2 is curved, while the locker 500 moves from the locking position to the unlocking position, initially, the position of the locker 500 is difficult to change. However, after moving a certain distance toward the unlocking position, the position of the locker 500 becomes easier to change. This is because a slope close to the locker 500 is steep, but a slope away from the locker 500 is gentle in the case where the pressure-applying surface 630A-2 is curved.

In other words, while the button 600-2 moves from the first button position to the second button position, initially, the position of the button 600-2 is difficult to change, but the position of the button 600-2 becomes easier to change after moving a certain distance toward to the second button position. As a result, if the button 600-2 is accidentally pressed, malfunction is prevented due to the difficulty of initial movement of the button 600-2. However, when the button 600-2 in intentionally pressed, the button 600-2 may easily operate after moving a certain distance.

The movement of the button 600-2 according to this embodiment is different from that of the button 600 according to the embodiment shown in FIGS. 1 to 17, because the button 600 has a flat pressure-applying surface 630A.

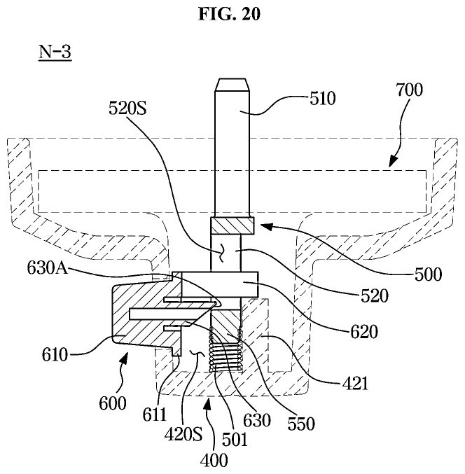

FIG. 20 is a cross-sectional view of a knob assembly N-3 of a cooking apparatus 1 according to an embodiment of the present disclosure.

Referring to FIG. 20, a knob assembly N-3 according to an embodiment of the present disclosure will be described.

The knob assembly N-3 may not include the button elastic member 601 between the button 600 and the locker 500.

In the case where the button 600 moves from the first button position to the second button position, the locker 500 may move from the locking position to the unlocking position along the pressure-applying surface 630A.

In the case where the button 600 is located at the second button position, the locker 500 may receive an elastic force to move from the unlocking position to the locking position from the locker elastic member 501.

In the case where the locker 500 moves from the unlocking position to the locking position, the locker support 520, which moves to the unlocking position along the pressure-applying surface 630A, may move the button 600 from the second button position to the first button position. That is, if the locker elastic member 501 has a sufficient elastic force, the button 600 may be moved from the second button position to the first button position even without the button elastic member 601.

In the embodiment illustrated in FIGS. 1 to 17, the knob assembly N may include the button elastic member 601 for the movement of the button 600 from the second button position to the first button position. In this embodiment, the knob assembly N-3 is different therefrom in that the button 600 may move from the second button position to the first button position without the button elastic member 601.

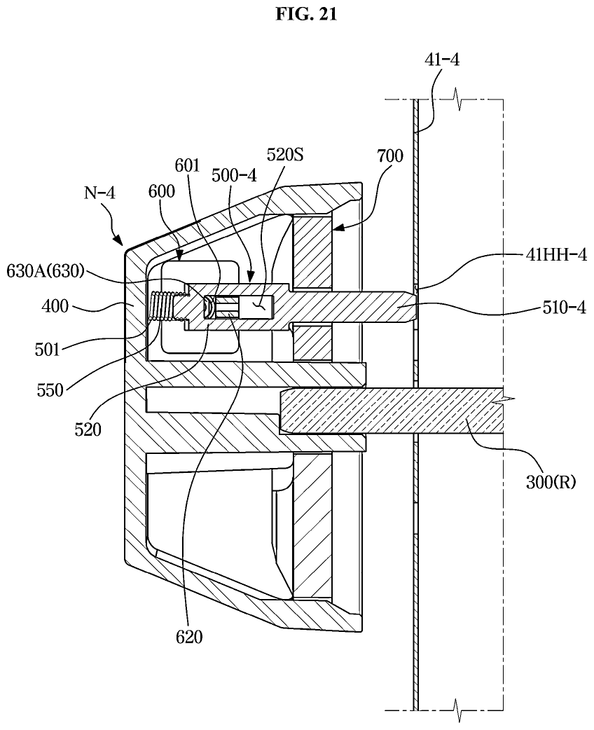

FIG. 21 is a cross-sectional view of a knob assembly N-4 of a cooking apparatus 1 according to an embodiment of the present disclosure and components related thereto.

Referring to FIG. 21, a locker 500-4 according to an embodiment of the present disclosure will be described.

The locker 500-4 may extend toward a control panel 41-4.

The locker 500-4 may not include the locker extension 530.

A locker contact component 510-4 may be provided to extend from the locker support 520.

The locker contact component 510-4 may be located adjacent to the shaft 300. Because the purpose of the locker 500-4 is to restrict the movement of the shaft 300, it is preferable to locate the locker 500-4 adjacent to a target to be restricted.

In the absence of the locker extension 530, the locker 500-4 may be closer to the shaft 300.

In the embodiment illustrated in FIGS. 1 to 17, the locker 500 may have the locker extension 530 from which the locker contact component 510 extends. The locker 500-4 according to this embodiment is different therefrom in that the locker contact component 510-4 may extend from the locker support 520 without the locker extension 530.

Unless clearly stated, the embodiments described above may be combined with other embodiments. Alternatively, unless one embodiment is clearly limited in combination with another embodiment, it should be considered that combinations between embodiments are possible. Combinations of one embodiment with another embodiment are deemed to be disclosed herein.

Although the embodiments of the present disclosure have been provided for illustrative purposes, the scope of the present disclosure is limited thereto. Various embodiments that may be modified and altered by those skilled in the art without departing from the principles and spirit of the present disclosure, the scope of which is defined in the claims, should be construed as falling within the scope of the present disclosure.

1. A cooking apparatus comprising:
a heat source;
a control panel;
a regulator body configured to operate the heat source and located adjacent to the control panel;
a shaft engaged with the regulator body and configured to move between a first shaft position, where rotation with respect to the regulator body is restricted, and a second shaft position, where rotation with respect to the regulator body is possible to operate the heat source;
a knob engaged with the shaft to move together with the shaft; and
a locking device provided at the knob and including a locker configured to move between a locking position, where the locker is inserted into the control panel to prevent the knob from being turned, and a unlocking position, where the locker is disengaged from the control panel to allow the knob to be turned, while the shaft is located at the second shaft position.

2. The cooking apparatus according to claim 1, further comprising:
a button configured to move between a first button position, where a movement of the locker from the locking position to the unlocking position is restricted and a second button position, where a movement of the locker from the locking position to the unlocking position is allowed,
wherein the button includes a pressure-applying protrusion configured to apply a pressure to the locker to move from the unlocking position to the locking position while the button moves from the first button position to the second button position.

3. The cooking apparatus according to claim 2, wherein
the pressure-applying protrusion has a pressure-applying surface that is contactable with the locker, and
the pressure-applying surface is inclined more toward the control panel in a direction from the first button position to the second button position of the button.

4. The cooking apparatus according to claim 3, wherein
the locker includes a locker support having a protrusion-accommodating space in which the pressure-applying protrusion is accommodated, and
the locker support moves in a state of being pressed by the pressure-applying surface while the button moves from the first button position to the second button position.

5. The cooking apparatus according to claim 3, wherein
the regulator body further includes a case having a stopper groove, and
the shaft includes:
a shaft body at least partially inserted into the case, and
a stopper protruding from the shaft body to be accommodated in the stopper groove while the shaft is located at the first shaft position and to be separated from the stopper groove while the shaft is located at the second shaft position.

6. The cooking apparatus according to claim 4, wherein the control panel has a locking hole at a position corresponding to the locker to accommodate the locker while the locker is located at the locking position.

7. The cooking apparatus according to claim 5, wherein a moving distance of the locker from the locking position to the unlocking position is greater than a moving distance of the shaft from the first shaft position to the second shaft position.

8. The cooking apparatus according to claim 4, further comprising:
a locker elastic member between the knob and the locker to apply a pressure to the locker from the unlocking position to the locking position.

9. The cooking apparatus according to claim 8, wherein the button includes a button hook extending through the protrusion-accommodating space to guide the button.

10. The cooking apparatus according to claim 9, further comprising:
a button elastic member between the locker and the button to apply a pressure to the button from the second button position to the first button position in a case where the locker is located at the unlocking position.

11. The cooking apparatus according to claim 10, wherein the button has a seating gap to accommodate a portion of the button elastic member and located between the button hook and the pressure-applying protrusion to mount the button elastic member on the button.

12. The cooking apparatus according to claim 9, wherein the button includes:
a button-grasping area from which the pressure-applying protrusion extends, and
a support flange extending outward from the button-grasping area to prevent the button from being separated outward from the knob.

13. The cooking apparatus according to claim 12, wherein the support flange is a lower support flange located at a lower position to prevent the button from extending downward beyond the button hook so as to linearly insert the button into the protrusion-accommodating space.

14. The cooking apparatus according to claim 6, wherein an end of the locker facing the regulator body has a tapered shape so as to be insertable into the locking hole.

15. The cooking apparatus according to claim 5, wherein the pressure-applying surface has an angle of 45 degrees or less.
